(19) United States
(12) Patent Application Publication
(10) Pub. No.: US 2018/0247313 A1
(43) Pub. Date: Aug. 30, 2018

(54) FINGERPRINT SECURITY ELEMENT (SE) MODULE AND PAYMENT VERIFICATION METHOD

(71) Applicant: HANGZHOU SYNOCHIP DATA SECURITY TECHNOLOGY CO., LTD., Hangzhou, Zhejiang (CN)

(72) Inventors: Xiansong LI, Hangzhou, Zhejiang (CN); Xulei WANG, Hangzhou, Zhejiang (CN); Hongchang LUO, Hangzhou, Zhejiang (CN); Junke FU, Hangzhou, Zhejiang (CN); Yun LI, Hangzhou, Zhejiang (CN); Boyun QIU, Hangzhou, Zhejiang (CN)

(21) Appl. No.: 15/755,051

(22) PCT Filed: Jul. 13, 2016
(86) PCT No.: PCT/CN2016/089886

§ 371 Date: Feb. 23, 2018

(30) Foreign Application Priority Data
Aug. 25, 2015 (CN) 201510528625.X

(51) Int. Cl. G06Q 20/40; G06K 9/00; G06Q 20/32; H04M 1/725; H04W 12/04; G06Q 20/38

(52) U.S. Cl. CPC G06Q 20/40145; G06K 9/0002; G06Q 20/3829; H04M 1/72522; H04W 12/04; G06Q 20/3227

(57) ABSTRACT

A fingerprint secure element (SE) module, having: a secure element (SE) communicatively connected to a mobile terminal application processor, with a biometric sensor for collecting fingerprints being connected to the secure element (SE), wherein the secure element (SE) includes a non-volatile memory for storing certificate information, user account information and fingerprint information, a fingerprint system management unit connected to the biometric sensor for realizing fingerprint collection, generation and comparison, a file system management unit connected to the non-volatile memory for managing various types of information, a security processing unit conducting core processing, and an algorithm management unit for data encryption and decryption. The fingerprint secure element (SE) module is high in security and high in verification efficiency.

### TECHNICAL FIELD

The present invention relates to a fingerprint secure element (SE) module and a payment verification method.

### BACKGROUND ART

At present, most of the mainstream fingerprint identification modules of mobile terminals on the market directly use a processor to extract, analyse and store fingerprint features. Although a fingerprint function can be realized in this way, most processors do not have such a high security level as that of a secure element, therefore when performing the payment by fingerprint, there will be a great risk. Since the personal fingerprint is unique and unchangeable top secret privacy information, and once is leaked out and then copied, the consequence will be unimaginable. A TrustZone technology, from ARM, integrated in a CPU is mostly used in the current mobile terminal fingerprint scheme, which is similar to virtualizing an area in ARM to realize the security performance. Although this approach can temporarily relieve the problem of security performance, the speed of security authentication is much slower than the update speed of a CPU in a mobile terminal. In addition, due to the increasingly great open performance permission of the mobile terminal currently and various dangers and risks brought by refurbishment, etc., the TrustZone technology integrated in the CPU of the mobile terminal also becomes unknown when faced with such situations.

### SUMMARY OF THE INVENTION

The present invention provides a fingerprint secure element (SE) module and a payment verification method with high security and high verification efficiency, wherein a secure element (SE) is a secure element with fingerprint storage and verification; and KEY is a password device with an identity authentication function.

The technical solution used in the present invention is:

a fingerprint secure element (SE) module, characterized by comprising: a secure element (SE) communicatively connected to a mobile terminal application processor, with a biometric sensor for collecting fingerprints being connected to the secure element (SE), wherein the secure element (SE) comprises a non-volatile memory for storing certificate information, user account information and fingerprint information, a fingerprint system management unit connected to the biometric sensor for realizing fingerprint collection, generation and comparison, a file system management unit connected to the non-volatile memory for managing various types of information, a security processing unit conducting core processing, and an algorithm management unit for data encryption and decryption. The present invention transforms the traditional method of the mobile terminal directly processing the fingerprint sensor into an approach of establishing an SE fingerprint module with an independent and secure chip mechanism, so that all the fingerprint-related operations have no relationship with a mobile terminal application processor, thereby not only ensuring the efficiency of renewal and research and development of the mobile terminal application processor, but also ensuring the fingerprint security and convenience. A biometric sensor is connected to the secure element (SE) and then connected to the mobile terminal application processor, so that fingerprint information is prevented from suffering man-made interception and tampering. Again with the double mechanism for the file system management unit and the security processing unit inside the secure element (SE), the SE fingerprint module is very convenient, safe and efficient when using the KEY. The fingerprint information collected by the biometric sensor is directly stored in the non-volatile memory in the SE, and features are generated and compared in the secure element (SE), so that man-made interception and tampering of the fingerprint information is prevented, thereby ensuring the security of the fingerprint information.

Further, the secure element (SE) communicates with the mobile terminal application processor in the form of ciphertext. The secure element (SE) sends, after completing the fingerprint-related operations, same in the form of ciphertext, while the mobile terminal decrypts same according to a security protocol and interprets the result. The mobile terminal only actively initiates a fingerprint-related operation command, and when the mobile terminal performs command interaction with the SE module, they both communicate in the form of ciphertext, and thus there is also no risk of being intercepted or being decoded after interception.

Further, the secure element SE is communicatively connected to the mobile terminal application processor via a serial data interface. The serial data interface can be common interfaces, such as SPI, IIC and UART. The ciphertext sent with an encryption effect cannot be intercepted and obtained by the outside.

The payment verification method for a fingerprint secure element (SE) module comprises the specific steps as follows:

(1) a mobile terminal acquiring payment information, and notifying a server to start a payment process;

(2) the mobile terminal, the server and a fingerprint secure element (SE) module performing authentication with one another, establishing a security channel and generating a session key;

(3) a secure element (SE) notifying the biometric sensor to collect fingerprints, the biometric sensor transmitting the collected fingerprint information to the secure element (SE) and generating fingerprint features in the secure element (SE), the secure element (SE) returning, to the mobile terminal, a message that valid fingerprint information is detected, the mobile terminal confirming payment and sending a payment command to the secure element (SE), and the secure element (SE) comparing the fingerprint information, authenticating identity, determining account information, performing payment processing and generating a transaction packet to the mobile terminal; or a mobile terminal confirming payment and sending a payment command to a secure element (SE), the secure element (SE) notifying the biometric sensor to collect fingerprints, the biometric sensor transmitting the collected fingerprint information to the secure element (SE) and generating fingerprint features and comparing the fingerprint information in the secure element (SE), authenticating identity, determining account information, confirming a certificate, performing payment processing and generating a transaction packet to the mobile terminal;

(4) the mobile terminal sending the transaction packet to the server;

(5) the server processing transaction information and returning the result to the mobile terminal; and

(6) the mobile terminal confirming that the payment is completed. The present method replaces, in a safe and convenient way, a previous approach in which payment needs to be verified by means of a short message or a password during the payment on the mobile terminal with this method. In addition, all the fingerprint-related operations are carried out in the secure element (SE), thereby effectively and safely ensuring the fingerprint confidentiality and security, and the sending of a random password of a KEY in a manner of ciphertext is effective and secure; and all the fingerprint information, including KEY information, can be ensured not to be tampered by other applications.

Further, the authentication process of the server and the secure element (SE) is as follows:

a. the server sending authentication information to the secure element (SE);

b. the secure element (SE) authenticating server information, and rejecting the authentication if the authentication fails; and after the authentication is successful, sending secure element (SE) authentication information to the server;

c. the server authenticating the secure element (SE) information, and rejecting the authentication if the authentication fails; and after the authentication is successful, sending confirmation information to the secure element (SE);

d. after the authentications in steps b and c are both successful, completing the authentication; and

e. generating a session key according to a key exchange protocol, and completing the establishment of a security channel.

Further, before the payment verification, it is necessary to register and store the fingerprint information and the account information in the secure element (SE), comprising specific steps as follows:

A. the mobile terminal acquiring registration information and confirming the permission of the mobile terminal, and after the confirmation is successful, registering the account information and notifying the secure element (SE) to record a payment fingerprint;

B. the secure element (SE) notifying the biometric sensor to collect fingerprints, and the secure element (SE) performing fingerprint collection to generate a synthetic template and returning a success instruction to the mobile terminal;

C. the mobile terminal sending a storage command to the secure element (SE), and the secure element (SE) storing the relevant account information and fingerprint information and returning a success instruction to the mobile terminal; and

D. the mobile terminal displaying registration success.

Further, the steps of confirming the permission of the mobile terminal comprise:

I. the mobile terminal sending a login instruction to the secure element (SE);

II. the secure element (SE) notifying the biometric sensor to collect fingerprints, and the secure element (SE) performing fingerprint collection, generation and comparison, and returning a success instruction to the mobile terminal; and

III. completing the confirmation of the permission of the mobile terminal.

The beneficial effects of the present invention lie in: establishing an SE fingerprint module with an independent security chip mechanism, so that all the fingerprint-related operations have no relationship with a mobile terminal, thereby not only ensuring the efficiency for renewal and research and development of the mobile terminal, but also ensuring the fingerprint security and convenience. All the fingerprint-related operations are carried out in the secure element (SE), thereby effectively and safely ensuring the fingerprint confidentiality and security, and the sending of a random password of a KEY in a manner of ciphertext is effective and secure; and all the fingerprint information, including KEY information, can be ensured not to be tampered by other applications. Only directly access to an SE fingerprint module by a mobile terminal via a serial communication interface is required to carry out development, thereby greatly shortening the development time and improving the working efficiency.

### BRIEF DESCRIPTION OF THE DRAWINGS

FIG. 1 is an application logic diagram of the present invention.

FIG. 2 is a schematic diagram of the specific structure of a secure element (SE) in the present invention.

FIG. 3 is a schematic diagram of a working mode of an interaction with a mobile terminal in the present invention.

FIG. 4 is a flowchart of payment verification in Embodiment II in the present invention.

FIG. 5 is a flowchart of the specific usage of payment verification in Embodiment II in the present invention.

FIG. 6 is a flowchart of payment verification in Embodiment III in the present invention.

FIG. 7 is a flowchart of the specific usage of payment verification in Embodiment III in the present invention.

FIG. 8 is a flowchart of registration in the present invention.

FIG. 9 is a flowchart of the specific usage of registration in the present invention.

### DETAILED DESCRIPTION OF EMBODIMENTS

The present invention is further illustrated below in conjunction with the specific embodiments, but the present invention is not limited to these specific implementations. A person skilled in the art should recognize that the present invention covers all the alternatives, modifications and equivalents that may be comprised within the scope of the claims.

### Embodiment I

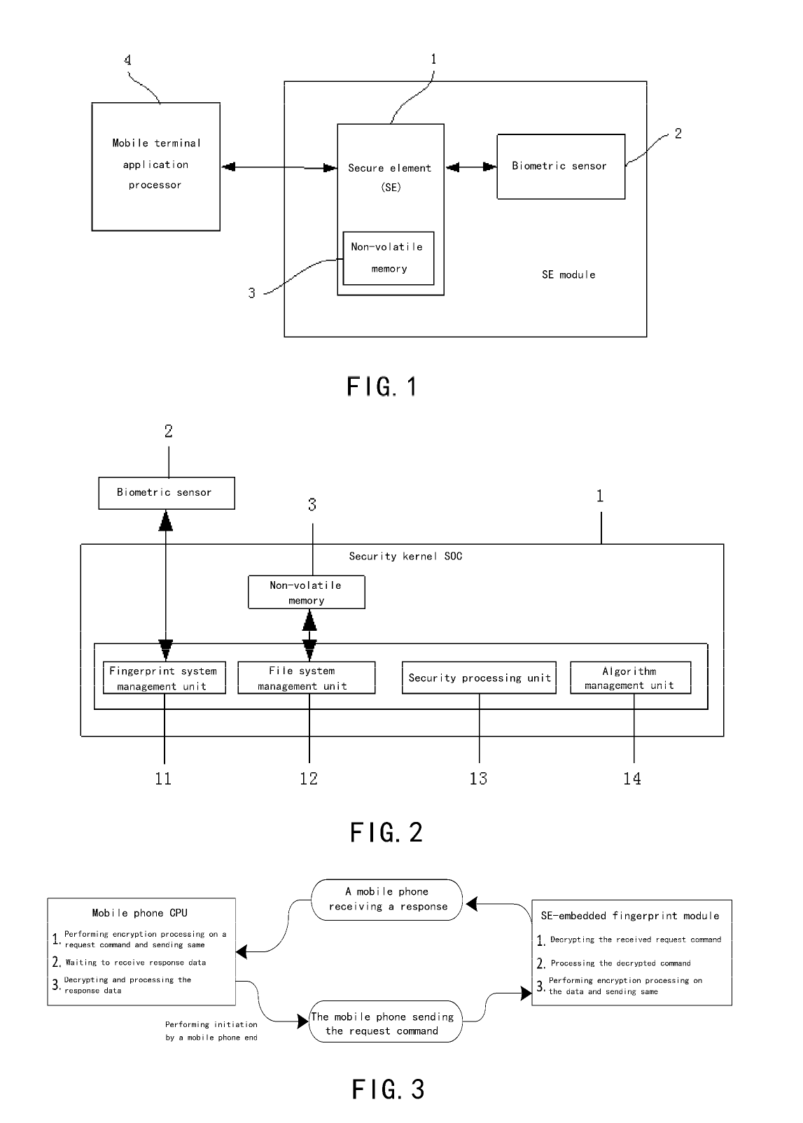

With reference to FIGS. 1-3, a fingerprint secure element (SE) module, comprising: a secure element SE1 communicatively connected to a mobile terminal application processor 4, with a biometric sensor 2 for collecting fingerprints being connected to the secure element SE1, wherein the secure element SE1 comprises a non-volatile memory 3 for storing certificate information, user account information and fingerprint information, a fingerprint system management unit 11 connected to the biometric sensor 2 for realizing fingerprint collection, generation and comparison, a file system management unit 12 connected to the non-volatile memory 3 for managing various types of information, a security processing unit 13 conducting core processing, and an algorithm management unit 14 for data encryption and decryption. The present invention transforms the traditional method of the mobile terminal directly processing the fingerprint sensor into an approach of establishing an SE fingerprint module with an independent and secure chip mechanism, so that all the fingerprint-related operations have no relationship with a mobile terminal application processor 4, thereby not only ensuring the efficiency of renewal and research and development of the mobile terminal, but also ensuring the fingerprint security and convenience. A biometric sensor is connected to the secure element (SE) and then connected to the mobile terminal application processor, so that fingerprint information is prevented from suffering man-made interception and tampering. Again with the double mechanism for the file system management unit 12 and the security processing unit 13 inside the secure element (SE), the SE fingerprint module is very convenient, safe and efficient when using the KEY. The fingerprint information collected by the biometric sensor 2 is directly stored in the non-volatile memory in the SE, and features are generated and compared in the secure element SE1, so that man-made interception and tampering of the fingerprint information is prevented, thereby ensuring the security of the fingerprint information.

The secure element SE1 in this embodiment is a SOC containing a security kernel, and the security kernel must have one or more of public and private key encryption and decryption algorithms, packet data encryption and decryption algorithms and hash algorithms; a security processing unit 13 realizes user fingerprint management processing, user account registration and cancellation processing, identity authentication processing and payment processing; and an algorithm management unit 14 is used to realize key generation, operation and storage, data encryption and decryption, data signature, check, etc., by means of a common algorithm or a state cryptographic algorithm. The biometric sensor 2 in this embodiment specifically refers to a fingerprint sensor. The non-volatile memory 3 stores all the relevant information about the fingerprint features, and has storage securities such as not being attacked and power-off holding. The communication interface between the secure element SE1 and the biometric sensor 2 may be a common interface such as SPI.

In this embodiment, the secure element SE1 communicates with the mobile terminal application processor 4 in the form of ciphertext. The secure element SE1 sends, after completing the fingerprint-related operations, same in the form of ciphertext, while the mobile terminal application processor 4 decrypts same according to a security protocol and interprets the result. The mobile terminal application processor 4 only actively initiates a fingerprint-related operation command, and when the mobile terminal application processor 4 performs command interaction with the SE module, they both communicate in the form of ciphertext, and thus there is also no risk of being intercepted or being decoded after interception.

In this embodiment, the secure element SE1 is communicatively connected to the mobile terminal application processor 4 via a serial data interface. The serial data interface can be common interfaces, such as SPI, IIC and UART. The ciphertext sent with an encryption effect cannot be intercepted and obtained by the outside.

### Embodiment II

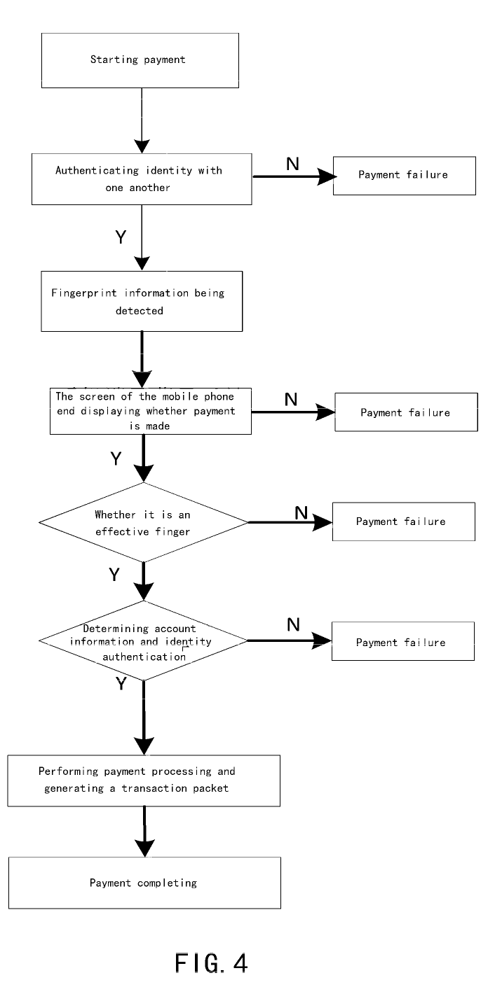

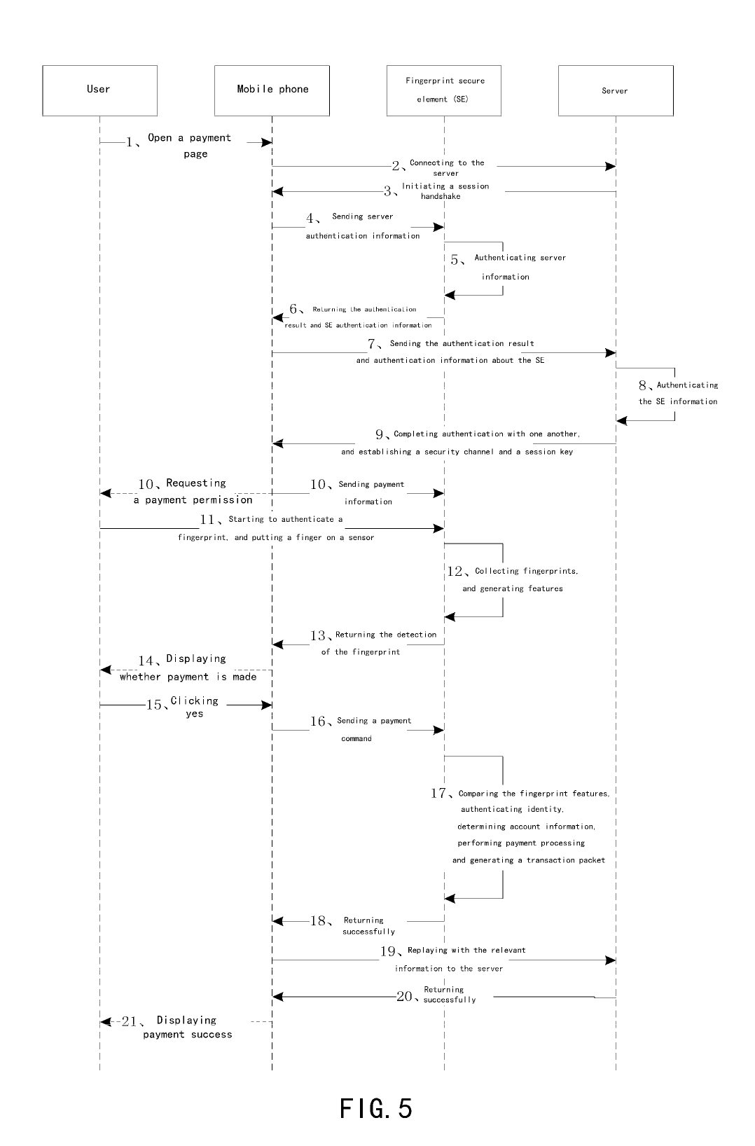

With reference to FIGS. 4 and 5, a payment verification method for a fingerprint secure element (SE) module comprises specific steps as follows:

(1) a mobile terminal acquiring payment information, and notifying a server to start a payment process;

(2) the mobile terminal, the server and a fingerprint secure element (SE) module performing authentication with one another, establishing a security channel and generating a session key;

(3) a secure element SE1 notifying the biometric sensor 2 to collect fingerprints, the biometric sensor 2 transmitting the collected fingerprint information to the secure element SE1 and generating fingerprint features in the secure element SE1, the secure element SE1 returning, to the mobile terminal, a message that valid fingerprint information is detected, the mobile terminal confirming payment and sending a payment command to the secure element SE1, and the secure element SE1 comparing the fingerprint information, authenticating identity, determining account information, performing payment processing and generating a transaction packet to the mobile terminal;

(4) the mobile terminal sending the transaction packet to the server;

(5) the server processing transaction information and returning the result to the mobile terminal; and

(6) the mobile terminal confirming that the payment is completed. The present method replaces, in a safe and convenient way, a previous approach in which payment needs to be verified by means of a short message or a password during the payment on the mobile terminal with this method. In addition, all the fingerprint-related operations are carried out in the secure element (SE), thereby effectively and safely ensuring the fingerprint confidentiality and security, and the sending of a random password of a KEY in a manner of ciphertext is effective and secure; and all the fingerprint information, including KEY information, can be ensured not to be tampered by other applications. The mobile terminal in the present embodiment takes the mobile phone as an example.

In this embodiment, the authentication process of the server and the secure element SE1 is as follows:

a. the server sending authentication information to the secure element SE1;

b. the secure element SE1 authenticating server information, and rejecting the authentication if the authentication fails; and after the authentication is successful, sending secure element SE1 authentication information to the server;

c. the server authenticating the secure element SE1 information, and rejecting the authentication if the authentication fails; and after the authentication is successful, sending confirmation information to the secure element SE1;

d. after the authentications in steps b and c are both successful, completing the authentication; and

e. generating a session key according to a key exchange protocol, and completing the establishment of a security channel.

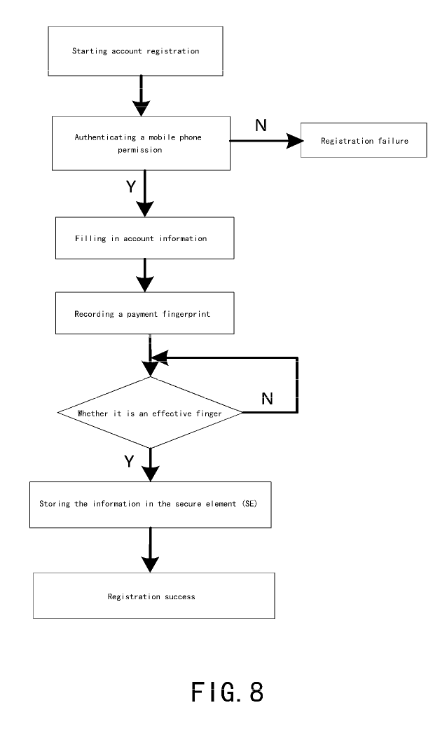

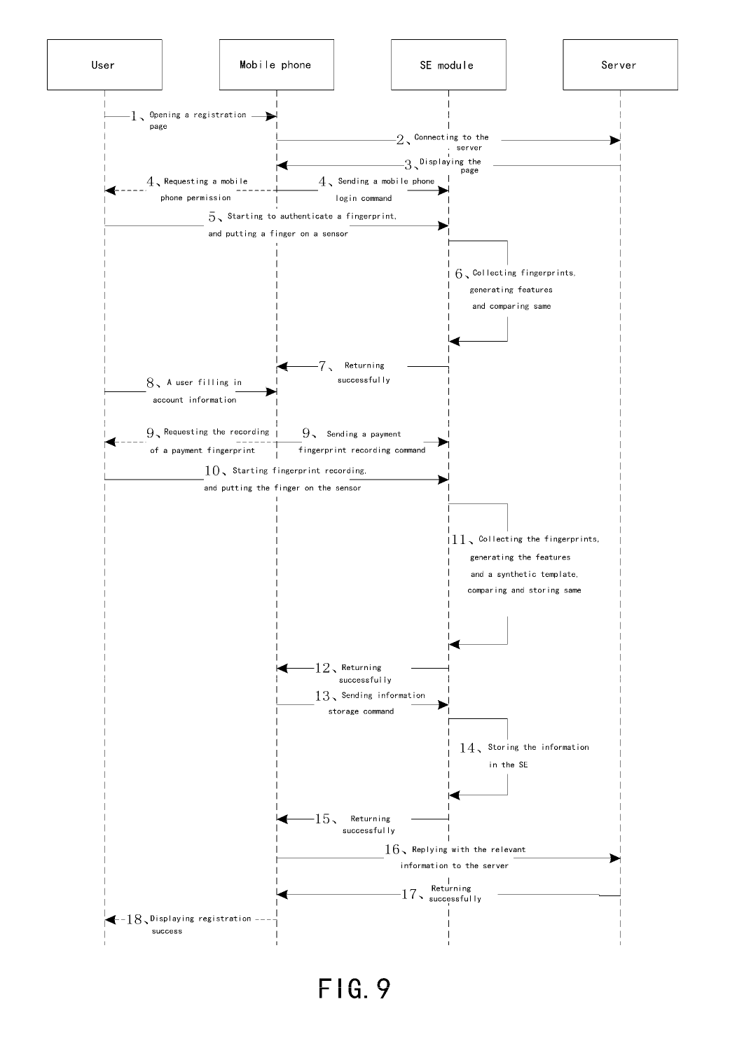

In this embodiment, before payment verification, it is necessary to register and store the fingerprint information and the account information in a secure element SE1, and the specific steps thereof are as follows with reference to FIGS. 8 and 9:

A. the mobile terminal acquiring registration information and confirming the permission of the mobile terminal, and after the confirmation is successful, registering the account information and notifying the secure element SE1 to record a payment fingerprint;

B. the secure element SE1 notifying the biometric sensor 2 to collect fingerprints, and the secure element SE1 performing fingerprint collection to generate a synthetic template and returning a success instruction to the mobile terminal;

C. the mobile terminal sending a storage command to the secure element SE1, and the secure element SE1 storing the relevant account information and fingerprint information and returning a success instruction to the mobile terminal; and

D. the mobile terminal displaying registration success.

In this embodiment, the steps of confirming the permission of a mobile terminal comprise:

I. the mobile terminal sending a login instruction to the secure element SE1;

II. the secure element SE1 notifying the biometric sensor 2 to collect fingerprints, and the secure element SE1 performing fingerprint collection, generation and comparison, and returning a success instruction to the mobile terminal; and

III. completing the confirmation of the permission of the mobile terminal.

The present invention establishes an SE fingerprint module with an independent security chip mechanism, so that all the fingerprint-related operations have no relationship with a mobile terminal, thereby not only ensuring the efficiency for renewal and research and development of the mobile terminal, but also ensuring the fingerprint security and convenience. All the fingerprint-related operations are carried out in the secure element (SE), thereby effectively and safely ensuring the fingerprint confidentiality and security, and the sending of a random password of a KEY in a manner of ciphertext is effective and secure; and all the fingerprint information, including KEY information, can be ensured not to be tampered by other applications. Only directly access to an SE fingerprint module by a mobile terminal via a serial communication interface is required to carry out development, thereby greatly shortening the development time and improving the working efficiency.

### Embodiment III

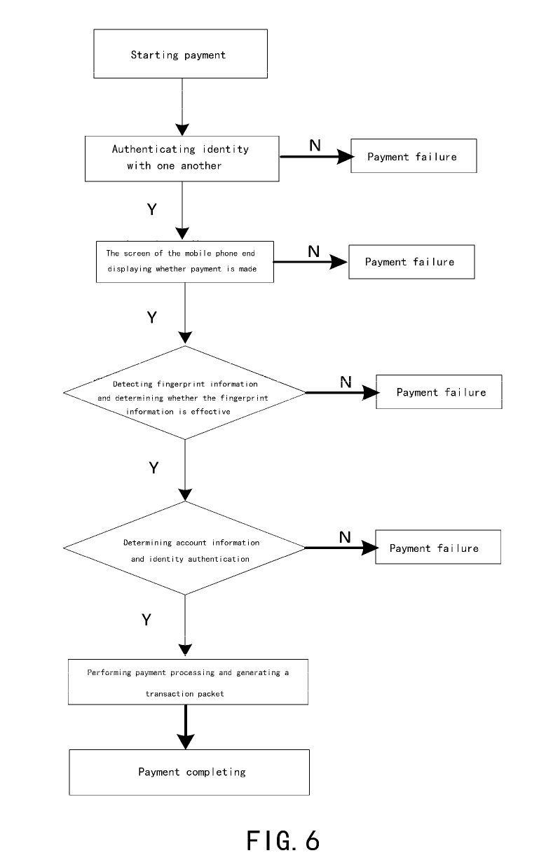

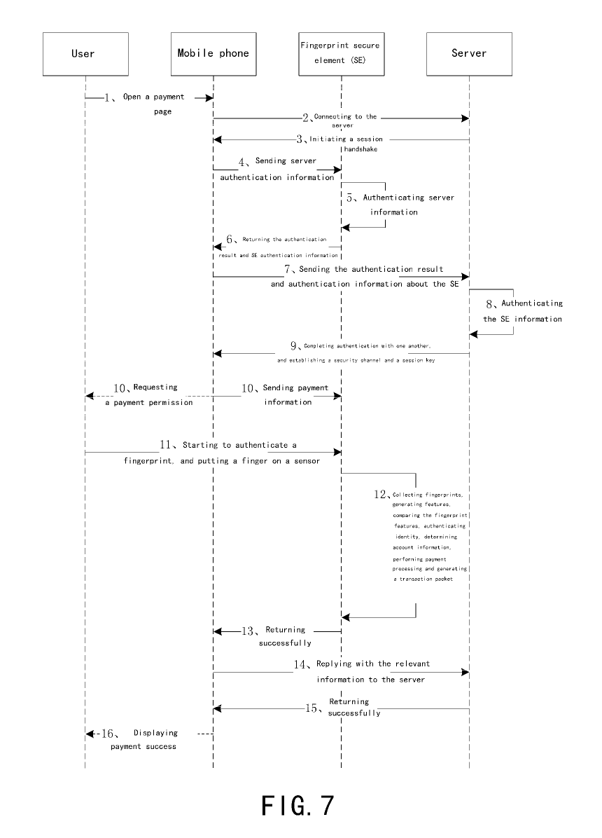

With reference to FIGS. 6 and 7, the difference between this embodiment and Embodiment II lies in step (3). In step (3), the order of fingerprint collection is different: a mobile terminal confirming payment and sending a payment command to a secure element SE1, the secure element SE1 notifying a biometric sensor 2 to collect fingerprints, the biometric sensor 2 transmitting the collected fingerprint information to the secure element SE1 and generating fingerprint features and comparing the fingerprint information in the secure element SE1, authenticating identity, determining account information, confirming a certificate, performing payment processing and generating a transaction packet to the mobile terminal; The remaining steps and functions are all identical to those in Embodiment II.

1. A fingerprint secure element (SE) module, comprising: a secure element (SE) communicatively connected to a mobile terminal application processor, with a biometric sensor for collecting fingerprints being connected to the secure element (SE), wherein the secure element (SE) comprises a non-volatile memory for storing certificate information, user account information and fingerprint information, a fingerprint system management unit connected to the biometric sensor for realizing fingerprint collection, generation and comparison, a file system management unit connected to the non-volatile memory for managing various types of information, a security processing unit conducting core processing, and an algorithm management unit for data encryption and decryption.

2. The fingerprint secure element (SE) module of claim 1, characterized in that the secure element (SE) communicates with the mobile terminal application processor in the form of ciphertext.

3. The fingerprint secure element (SE) module of claim 1, characterized in that the secure element (SE) is communicatively connected to the mobile terminal application processor via a serial data interface.

4. A payment verification method for the fingerprint secure element (SE) module of claim 1, comprising:
(1) a mobile terminal acquiring payment information, and notifying a server to start a payment process;
(2) the mobile terminal, the server and the fingerprint secure element (SE) module performing authentication with one another, establishing a security channel and generating a session key;
(3) the secure element (SE) notifying the biometric sensor to collect fingerprints, the biometric sensor transmitting the collected fingerprint information to the secure element (SE) and generating fingerprint features in the secure element (SE), the secure element (SE) returning, to the mobile terminal, a message that valid fingerprint information is detected, the mobile terminal confirming payment and sending a payment command to the secure element (SE), and the secure element (SE) comparing the fingerprint information, authenticating identity, determining account information, performing payment processing and generating a transaction packet to the mobile terminal; or the mobile terminal confirming payment and sending a payment command to the secure element (SE), the secure element (SE) notifying the biometric sensor to collect fingerprints, the biometric sensor transmitting the collected fingerprint information to the secure element (SE) and in the secure element (SE), generating fingerprint features and comparing the fingerprint information, authenticating identity, determining account information, confirming a certificate, performing payment processing and generating a transaction packet to the mobile terminal;
(4) the mobile terminal sending the transaction packet to the server;
(5) the server processing transaction information and returning a result to the mobile terminal; and
(6) the mobile terminal confirming that the payment is completed.

5. The payment verification method of claim 4, wherein the authentication process of the server and the secure element (SE) is as follows:
a. the server sending authentication information to the secure element (SE);
b. the secure element (SE) authenticating server information, and rejecting the authentication if the authentication fails; and after the authentication is successful, sending secure element (SE) authentication information to the server;
c. the server authenticating the secure element (SE) information, and rejecting the authentication if the authentication fails; and after the authentication is successful, sending confirmation information to the secure element (SE);
d. after the authentications in said b and c are both successful, completing the authentication; and
e. generating a session key according to a key exchange protocol, and completing the establishment of a security channel.

6. The payment verification method of claim 4, wherein before the payment verification, it is necessary to register and store the fingerprint information and the account information in the secure element (SE), comprising:
A. the mobile terminal acquiring registration information and confirming the permission of the mobile terminal, and after the confirmation is successful, registering the account information and notifying the secure element (SE) to record a payment fingerprint;
B. the secure element (SE) notifying the biometric sensor to collect fingerprints, and the secure element (SE) performing fingerprint collection to generate a synthetic template and returning a success instruction to the mobile terminal;
C. the mobile terminal sending a storage command to the secure element (SE), and the secure element (SE) storing relevant account information and fingerprint information and returning a success instruction to the mobile terminal; and
D. the mobile terminal displaying registration success.

7. The payment verification method of claim 6, wherein the step of confirming of the permission of the mobile terminal comprises:
I. the mobile terminal sending a login instruction to the secure element (SE);
II. the secure element (SE) notifying the biometric sensor to collect fingerprints, and the secure element (SE) performing fingerprint collection, generation and comparison, and returning a success instruction to the mobile terminal; and
III. completing the confirmation of the permission of the mobile terminal.
